(19) United States
(12) Patent Application Publication
(10) Pub. No.: US 2008/0028538 A1
(43) Pub. Date: Feb. 7, 2008

(54) UNIVERSAL TOOL FOR SMALL FASTENERS

(76) Inventor: Joshua Freilich, Santa Fe, NM (US)

Correspondence Address: PEACOCK MYERS, P.C., 201 THIRD STREET, N.W., SUITE 1340, ALBUQUERQUE, NM, 87102, US

(21) Appl. No.: 11/833,527

(22) Filed: Aug. 3, 2007

Related U.S. Application Data
(60) Provisional application No. 60/821,506, filed on Aug. 4, 2006.

(51) Int. Cl. B25B 9/00

(52) U.S. Cl. 7/125

(57) ABSTRACT

The present invention relates to a tool for working with the fasteners on small equipment, particularly small screws and nuts, and most particularly those on eyeglasses, watches, clocks, microscopes, telescopes, electronic devices and other items.

### CROSS-REFERENCE TO RELATED APPLICATIONS

This application claims priority to and the benefit of the filing of U.S. Provisional Patent Application Ser. No. 60/821,506, entitled “UNIVERSAL TOOL FOR SMALL NUTS AND SCREWS”, filed on Aug. 4, 2006 and the specification thereof is incorporated herein by reference.

### BACKGROUND OF THE INVENTION

1. Field of the Invention (Technical Field)

The present invention relates to a tool for working with screws, nuts and other fasteners on equipment, particularly small screws and nuts, and most particularly those fasteners on eyeglasses, watches, clocks, microscopes, telescopes, electronic devices, and other items.

2. Description of Related Art

The art consists of small wrenches for the removal and insertion of nuts and screws on eyeglasses and other items. A different wrench is needed for each type of nut and screw.

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

### BRIEF SUMMARY OF THE INVENTION

The present invention relations to a tool for gripping fasteners and a method for using the tool. The preferred tool comprises an outer sleeve; a gripping portion disposed in an interior of the outer sleeve and located at an end of the tool, the gripper portion comprising multiple prongs; a push mechanism disposed on an opposite end of the tool from the gripping portion; the gripping portion, when actuated, extending out of and retracting into the sleeve; the prongs opening when the gripping portion is in an extended position and the prongs closing when the gripping portion is retracted and in a closed position; and a ledge disposed above the push mechanism enabling a user to push the push mechanism. The push mechanism engages a spring disposed in the tool and the spring actuates the gripping portion.

In the preferred embodiment, at least one of the prongs is threaded and/or indented (or cut-away). Each prong preferably comprises an incline at a top end and an opposed incline at a bottom end. The outer sleeve preferably comprises a rigid material. The tool may further comprise a lock. The gripping portion may further comprise a magnet. The ledge preferably comprises a flat section for engaging with several of a user's fingers. The push mechanism preferably comprises a flat portion for engaging with the user's thumb. The user's thumb and fingers compress on the tool (such as a syringe), thereby pushing the push mechanism, which actuates the spring and the spring extends the gripping portion out of the sleeve, opening the prongs to accommodate the fastener(s). The finger portion(s) of the tool may be knurled to prevent slippage.

When the tool is in a retracted or closed position, the tip of the prong(s) may engage with a fastener. When the tool is in an extended position (extended from the sleeve), the prongs of the gripping portion engages different sizes or types of fastener, making this configuration universal to accommodate these different types and sizes of fasteners.

The tool is particularly useful for eyeglasses, but can be used on other types of equipment or objects.

The present invention relates to a tool for working with fasteners on equipment, particularly for fasteners on eyeglasses.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of the preferred embodiment of the present invention;

FIG. 2 is a close-up view of the extended interior portion of the FIG. 1 embodiment;

FIGS. 3a and b are side view schematics of the FIG. 1 embodiment;

FIG. 4 is a top view schematic of an open position of the FIG. 1 embodiment; and

FIGS. 5a and b are side views of the exterior and interior components of the FIG. 1 embodiment.

### DETAILED DESCRIPTION OF THE INVENTION

The present invention relates to a tool for working with fasteners, particularly small nuts and screws, and most particularly those used for eyeglasses, watches, clocks, microscopes, telescopes, electronic devices, and other items. The preferred embodiment of the present invention is shown in the drawings. As shown therein, the tool is made of metal or other rigid material and has a spring loaded “gripping portion” which is disposed in the interior of the tool. At rest, the tool end can be used for a small size of fastener. When the gripping portion is extended by pushing on one end of the tool, the gripping portion opens and becomes universal to accommodate different types and sizes of fasteners.

The tool preferably comprises an exterior portion, a pushing mechanism and a gripping portion. The gripping portion is preferably threaded and indented to better engage with the fasteners.

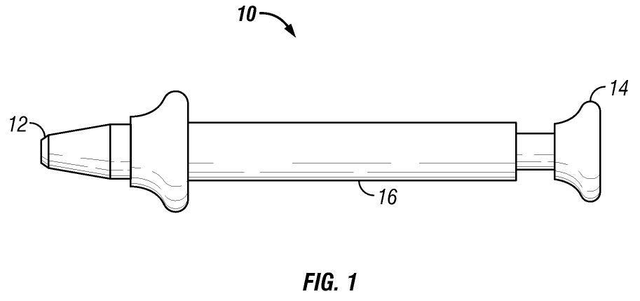

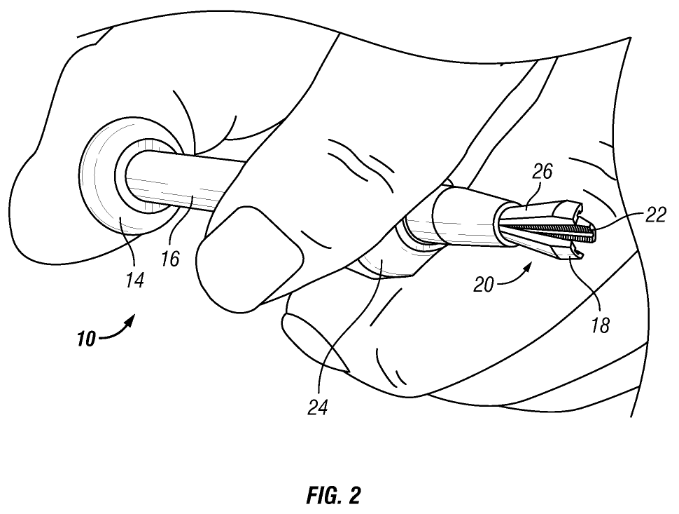

FIG. 1 shows a side view of the preferred embodiment of the tool 10, at rest. At rest, and in a closed and retracted position, tip 12 of tool 10 may be used for any particular size of fastener. When in an open position (see FIG. 2), tool 10 is universal and may be used for any number of sizes and types of fasteners.

The term “fastener” as used in the specification and claims includes but is not limited to nuts, screws, bolts, clips, nails, staples, rivets, pins, posts, and the like or any hardware device that holds, joins affixes or fastens objects together. The terms “fastener” and/or “screw” and/or “nut”, are intended to include all sizes, shapes, and head variations and is intended but not to be limited to include straight and threaded embodiments of fasteners. The invention is not limited to use on any particular nuts, screws or fasteners.

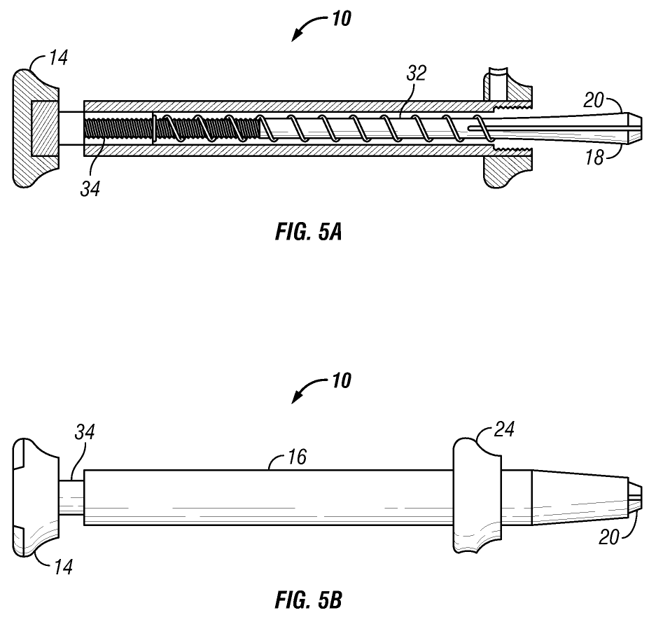

Push mechanism 14 is pressed and thereby extends gripping portion 20. As gripping portion 20 is extended outward from sleeve 16, it opens wider and wider and thus different sizes of fasteners are accommodated (see FIG. 2). Gripping portion 20 is extended and retracted into outer sleeve 16 preferably by a user's thumb pushing or releasing push mechanism 14 which engages spring 32 and gripping portion 20 so that it extends or retracts into sleeve 16. Outer sleeve 16 comprises spring loaded mechanism 32 (see FIG. 5a).

In the preferred embodiment, shown in FIG. 2, gripping portion 20 comprises multiple prongs 21. FIG. 2 shows three prongs 21, but any multiple of prongs may be used. An advantage of the present invention is the universal nature of the tool to work with all shapes and sizes of nuts and screws and other fasteners without changing the jaws or prongs. Each prong 21 preferably comprises indentations 30 with threads 22 disposed thereon, for better contact with the fastener. Each prong 21 preferably has incline 26 at the top and opposite incline 26 at the bottom; this helps with holding onto the fastener and enables gripping portion 20 to extend and retract from sleeve 16 using push mechanism 14. Push mechanism 14 is preferably operable by a single hand of a user, where a bottom of push mechanism 14 preferably has a flat bottom portion 14 that rests upon a thumb.

At or near a top end of tool 10, ledge 24 is disposed between the second and third fingers so that the second and third fingers and thumb push towards each other, similar to operating a syringe. This action causes spring-loaded interior mechanism 32 (see FIG. 5a), located inside outer sleeve 16, to push gripping portion 20 outside of the top end of tool 10, at a length and width desired by the user, in order to accommodate any fastener. The top end of tool 10 is preferably sloped to accommodate gripping portion 20 when it is disposed within tool 10. The finger portion(s) of the tool may be knurled to prevent slippage.

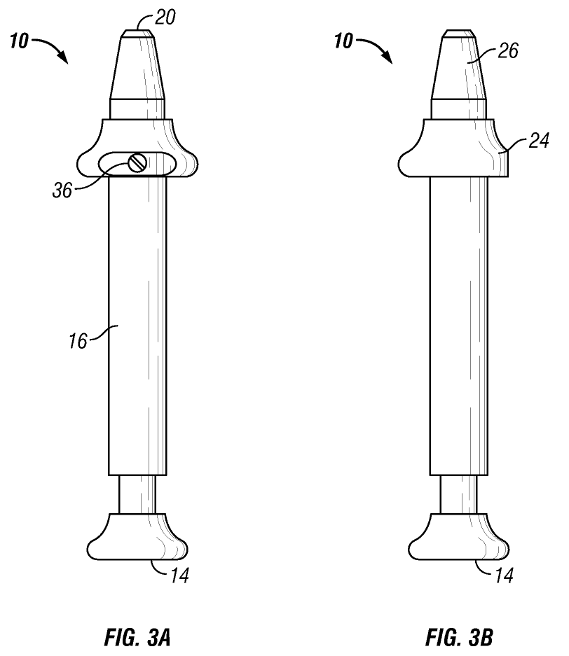

FIGS. 3a and b show diagrams of the preferred embodiment of tool 10 at rest or in a retracted position. Outer sleeve 16 and push mechanism 14 as well as finger ledge 24 are shown. Tool 10 works by engaging push mechanism 14. Gripping portion 20 then extends and opens upon extension. The universal tool is preferably extended to fit the fastener on the equipment (e.g. eyeglasses), and indentation or cut-aways 30 and threads 22 hold fasteners. Tool 10 then tightens or loosens the fastener with efficiency. In an alternative embodiment, locking mechanism 36 is used to lock tool 10 into one position for different sizes of fasteners. The preferred embodiment uses a flexible push mechanism 14.

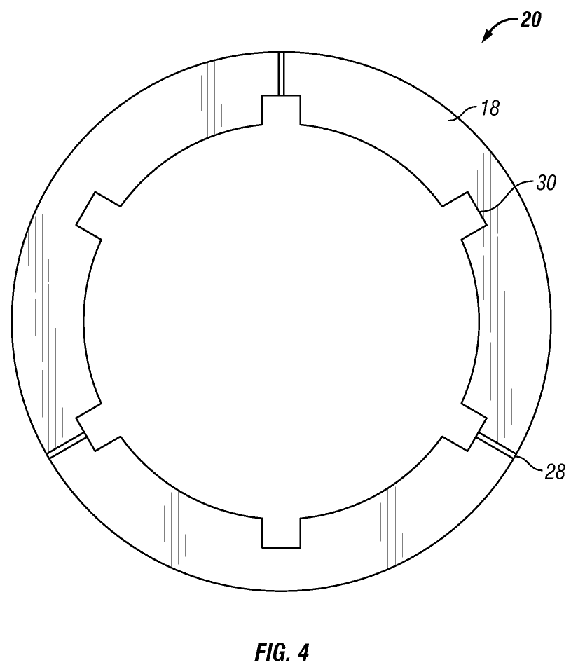

FIG. 4 shows a top view of three prongs 21 of gripping portion 20 of the preferred embodiment. Prong 21 is split from other prongs 21. Indentation or cut-aways 30 are shown in the top view. This view shows threading 22 that preferably facilitates gripping of the fasteners.

FIGS. 5a and b show side views of the interior and exterior components of the preferred embodiment of tool 10. Spring 32 allows spring-loaded push mechanism 14, which is attached to piston 34, to extend gripping portion 20. As shown therein, spring 32 and piston 34 mechanism is disposed beneath gripping portion 20. FIG. 5a shows an interior view. When exterior push mechanism 14 is pushed, piston 34 and spring mechanism 32 push gripping portion 20 out of the end or top of tool 10 so that it can grab fasteners. FIG. 5b is an exterior view of tool 10, with outer sleeve 16, finger ledge 24, gripping portion 20, piston 34 and push mechanism 14 shown. Alternative embodiments include but are not limited to locking mechanisms, hydraulic systems, and capping mechanisms.

While the preferred embodiment of the invention is directed to eyeglasses, the invention is also useful in any application that uses small fasteners, including but not limited to computers, electronic devices, toys, watches, clocks, microscopes, telescopes and other items

Alternative embodiments of the invention include magnetization of the grabbing portion, threadless gripping portions, locking mechanisms, capping mechanisms, battery or electrically operated gripping portions and combinations thereof.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A tool for gripping a fastener comprising:
an outer sleeve;
a gripping portion disposed in an interior of said outer sleeve and located at an end of said tool, said gripper portion comprising multiple prongs;
a push mechanism disposed on an opposite end of said tool from said gripping portion;
said gripping portion, when actuated, extending out of and retracting into said sleeve;
said prongs opening when said gripping portion is in an extended position and said prongs closing when said gripping portion is retracted and in a closed position; and
a ledge disposed above said push mechanism enabling a user to push said push mechanism;
said push mechanism engaging a spring disposed in said tool; and
said spring actuating said gripping portion.

2. The tool of claim 1 wherein at least one said prong is threaded.

3. The tool of claim 1 wherein said outer sleeve comprises a rigid material.

4. The tool of claim 1 wherein an end of said gripping portion, in said retracted and closed position, engages with a fastener.

5. The tool of claim 1 wherein said prongs, when said gripping portion is in said extended position, engages the fastener.

6. The tool of claim 1 wherein said gripping portion is universal to accommodate different types and sizes of fasteners.

7. The tool of claim 1 wherein at least one said prong is indented or has a cut-away portion.

8. The tool of claim 1 useful for at least one item selected from the group consisting of:
eyeglasses;
watch;
clock;
microscope;
telescope;
electronic device; and
toy.

9. The tool of claim 1 wherein each said prong comprises an incline at a top end and an opposed incline at a bottom end.

10. The tool of claim 1 further comprising a lock.

11. The tool of claim 1 wherein said gripping portion comprises a magnet.

12. The tool of claim 1 wherein said ledge comprises a flat section for engaging with several of a user's fingers.

13. A method for gripping fasteners, the method comprising the steps of:
providing a tool for gripping a fastener comprising an outer sleeve; a gripping portion disposed in an interior of the outer sleeve and located at an end of the tool, the gripper portion comprising multiple prongs; a push mechanism disposed on an opposite end of the tool from the gripping portion; and a ledge disposed above the push mechanism enabling a user to push said push mechanism;
extending the gripping portion out of and retracting the gripping portion into the sleeve;
opening the prongs when the gripping portion is in an extended position and closing the prongs when the gripping portion is retracted and in a closed position;
pushing on the push mechanism by using the opposed ledge and engaging a spring disposed in the tool; and
activating the gripping portion with the spring.

14. The method of claim 13 comprising extending the gripping portion outside of a top end of the tool, at a length and width desired by a user, in order to accommodate any size or type of fastener.

15. The method of claim 13 comprising extending the gripping portion to fit a fastener and then tightening or loosening the fastener.
